(19) United States
(12) Patent Application Publication
(10) Pub. No.: US 2025/0316974 A1
(43) Pub. Date: Oct. 9, 2025

(54) THREE-PHASE ALTERNATIVE CURRENT SERIES TYPE HYBRID CIRCUIT BREAKERS

(71) Applicant: SYNQUE CONSULTING INC., WHITE ROCK (CA)

(72) Inventors: Zheng John SHEN, White Rock (CA); Amirhussein ZIA, Surrey (CA); Hamid Jafarabadi ASHTIANI, Surrey (CA); Soroush NAEIJI, Surrey (CA)

(73) Assignee: SYNQUE CONSULTING INC., WHITE ROCK, BC (CA)

(21) Appl. No.: 18/962,506

(22) Filed: Nov. 27, 2024

Related U.S. Application Data
(63) Continuation-in-part of application No. 18/625,383, filed on Apr. 3, 2024.

(51) Int. Cl. H02H 3/08; H02H 1/00

(52) U.S. Cl. CPC H02H 3/083; H02H 1/0007

(57) ABSTRACT

Series-type hybrid circuit breaker schemes to provide protection against circuit faults in three-phase AC power systems with cost, size, and efficiency advantages. Embodiments of this invention include a series-type hybrid circuit breaker (SHCB) that quickly forces a fault current into a high-frequency small-amplitude AC ripple current with zero crossings and allows a series-connected mechanical switch to disconnect the faulty branch safely.

### CROSS REFERENCE TO RELATED APPLICATION

This application is a continuation-in-part of U.S. application Ser. No. 18/625,383, filed on 3 Apr. 2024. The co-pending parent application is hereby incorporated by reference herein in its entirety and is made a part hereof, including but not limited to those portions which specifically appear hereinafter.

### FIELD OF THE INVENTION

This invention relates generally to circuit breakers in three-phase alternating current (AC) power distribution or transmission systems. More particularly, it relates to series-type hybrid circuit breakers that quickly force a fault current into a form of high-frequency small-amplitude AC ripple current and allows a series-connected mechanical switch or circuit breaker to disconnect the faulty branch safely in a three-phase AC power system.

### BACKGROUND OF THE INVENTION

Mechanical circuit breakers (MCBs), such as vacuum interrupter (VI) and molded case circuit breaker (MCCB), are widely used in AC power distribution systems. They rely on natural AC current zero crossings to extinguish the breaking arc, but suffer from a relatively long fault interruption time typically of a few AC cycles (tens of milliseconds) that results in electrothermal overstress, degradation, or even catastrophic failure of the power cables and apparatus. Solid-state circuit breakers (SSCBs) can quickly interrupt a fault current within tens of microseconds but suffer from high conduction losses. The most distinct advantage of the SSCBs is the fast switching of the power semiconductor devices during infrequent fault interruption operation while a possible disadvantage is the continuous flow of current through the same semiconductor devices during normal operation. It would be highly desirable to use the fast switching property of the semiconductor devices in new circuit protection architectures during fault interruption but avoid running current continuously through them during normal operation.

Hybrid circuit breakers (HCB) offer a very low conduction loss but only a moderate response time of several milliseconds (much slower than SSCB but faster than MCB). It is worth noting that the response time of an HCB is determined by the opening speed of the main mechanical switch, which is often too long for many modern AC power systems. Current HCBs are of parallel nature (although the word “parallel” is not explicitly used), in which a commutation path is connected in parallel with the main mechanical breaker. The fault current in the mechanical breaker is initially commutated to the commutation path to create current zero crossings in various forms to aid the safe opening of the mechanical breaker. The commutation path will be interrupted without arcing afterwards by turning off the semiconductor switch in the path. One known HCB design concept is to use an LC resonant circuit made of an inductor and capacitor in the commutation path to generate a current pulse with higher amplitude than the fault current to be interrupted, and thus current zero crossings in the mechanical circuit breaker. Such a pulse can be created by releasing the charge in a pre-charged capacitor by a semiconductor switch. The LC resonant circuit can also be excited by a voltage source converter as described in U.S. Patent Publication 2020/0251295. Disadvantages of these resonant-type HCBs include a finite excitation time taken to achieve artificial current zero crossings in the MCB and a very high current rating required for the semiconductor switch to turn on and turn off the resonant current.

A series-type HCB (SHCB) concept was recently invented to use a pulse transformer in series with a mechanical switch (MS) or mechanical circuit breaker (MCB) to force a fault current into a near-zero small AC ripple current by injecting and regulating a counter voltage into the main power circuit (U.S. Pat. No. 11,670,933 and Z. J. Shen et al., “A Series-Type Hybrid Circuit Breaker Concept for Ultrafast DC Fault Protection,” IEEE Transactions on Power Electronics, Vol. 37, No. 6, 2022, each incorporated by reference). This method offers a very low conduction loss and a very short response time to drive the fault current to zero or near-zero. A recent SHCB (U.S. patent application Ser. No. 18/625,383) teaches a bidirectional SHCB for both DC and single-phase AC applications and the use of a small capacitor which can be recharged by the main power loop periodically to maintain its operating voltage through an H-bridge power circuit. This SHCB can be naturally extended to common three-phase AC applications, as shown in FIG. 1B, but not without a severe penalty of three-fold increase in component cost and physical size.

### SUMMARY OF THE INVENTION

An objective of this invention is to provide several new SHCB protection schemes for three-phase AC power systems without said 3-fold cost and size penalty. The three-phase SHCB can quickly (e.g., within several tens of microseconds) reduce a fault current in one or all of the three phases to zero and hold it near zero for a certain period of time (e.g., hundreds of microseconds) while the series-connected mechanical switch can be safely opened to disconnect the faulty branch. The main advantages of this invention include microsecond-range of fault current reduction and low on-state power losses at a relatively low implementation cost.

The present invention includes several series-type hybrid circuit breaker schemes to provide protection against circuit faults in three-phase AC power systems. Embodiments of this invention provide or include a series-type hybrid circuit breaker (SHCB) that quickly forces a fault current into a form of high-frequency small-amplitude AC ripple current with zero crossings and allows a series-connected mechanical switch (MS) to disconnect the faulty branch safely. The SHCB injects a transient counter voltage pulse via a pulse transformer into the main power loop upon detection of an overcurrent or other fault conditions and forces the fault current to zero and remain in a form of high-frequency small-amplitude AC ripple current with zero crossings. A power electronic circuit on the primary side of the transformer controls the discharge of a pre-charged capacitor to generate a counter voltage pulse during the first phase (termed “active” mode) of each switching cycle of the fault interruption process. During the subsequent second phase (termed “recharge” mode), the power electronic circuit changes the polarity of the injected secondary voltage and forces the fault current change its direction and cross zero again. The capacitor is recharged to its original or a slightly lower voltage by the main power circuit in the “recharge” mode. During the subsequent third phase (termed “inactive” mode), the power electronic circuit decouples the capacitor from the transformer until the next switching cycle. In the various embodiments disclosed herein, the power electronic circuit generally operates among those three modes in different manners, but all aims at forcing the current of one or more phases into a near-zero AC ripple current. The fault interruption process typically takes a time of several zero crossings (e.g., 5 to 20) until the MS opens safely. Embodiments of the invention use one or more pulse transformer which injects counter voltages in the main power loop during the “active” and “recharge” modes, but behaves as a passive inductor during the “inactive” mode. Note that the power electronic circuit remains inactive and does not incur any power loss during normal operation. Embodiments of this invention offer significantly reduced component count and size (e.g., ⅓ to ½ reduction).

Since the main power loop current flows through the secondary winding of the pulse transformer, the DC or AC resistance of the secondary winding will inevitably cause additional power loss and must be mitigated by properly sizing the winding wires. Embodiments of the invention avoid this disadvantage by adding a tertiary winding in the existing transformers already used in the three-phase AC power system.

Semiconductor switches such as silicon or silicon carbide insulated-gate bipolar transistors (IGBTs), thyristors, power MOSFETs, diodes, along with a digital controller, can be used to control the SHCB operation. Note that none of them conduct any current under normal operation. They are only activated and incur switching power losses during a short period of fault interruption (e.g., less than 0.5-5 ms).

Embodiments of the invention include a circuit protection apparatus for interrupting a three-phase fault current and isolating the fault from the power system. The apparatus includes a power electronic circuit operable to force a fault current in a main power circuit to cross zero a number of times (e.g., 5 to 20) in form of high-frequency small-amplitude AC ripple current within a specified response time window upon detection of a fault condition. The apparatus desirably also includes a mechanical switch (MS) or circuit breaker (MCB) in series connection with said non-resonant current zero-crossing generation circuit via a pulse transformer, the mechanical circuit breaker operable to interrupt the fault current and isolate the faulty circuit branch within said time window. The apparatus desirably also includes at least one current sensor operable to detect the direction and amplitude of current in the main power circuit.

In embodiments, the power electronic circuit includes at least one capacitor operable to discharge and recharge during the fault interruption process, a plurality of semiconductor switches and/or diodes, a control circuit to control the switching of the semiconductor switches, a pulse transformer operable to inject a transient voltage to the main power circuit to force the fault current to cross zero a plurality of times during the fault interruption process, and an isolated power supply to pre-charge at least one capacitor to certain voltage levels in preparation for generating the transient voltage.

In embodiments, the specified response time is between about 0.5 and 5 milliseconds.

In embodiments, the amplitude of said high-frequency AC ripple current is in a range of 5 to 30% the nominal current of the main power circuit.

In embodiments, the frequency of said high-frequency AC current is in a range of one to several tens of kilohertz.

In embodiments, the pulse transformer comprises a primary winding connected to the power electronic circuit of the non-resonant current zero-crossing generation circuit and a secondary winding connected in series with the main power circuit.

In embodiments, the pulse transformer comprises a primary winding connected to the upstream AC power source, a secondary winding connected to the downstream power load, and a tertiary winding connected to the power electronic circuit of the non-resonant current zero-crossing generation circuit.

In embodiments, the capacitor is discharged to and subsequently recharged by the main power circuit during the fault interruption process.

In embodiments, the semiconductor switches are operable to control the current going through the pulse transformer and comprise one or more selected from the group consisting of insulated-gate bipolar transistors (IGBTs), thyristors, and power MOSFETs made of silicon or other semiconductors.

The invention further includes a method for interrupting three-phase AC fault currents and isolating the fault from a power system. The method includes steps of: detecting a fault current, current direction, and fault phrase; activating a non-resonant current zero-crossing generation circuit to force the fault current to cross zero a plurality of times in form of high-frequency small-amplitude AC ripple current within a specified response time window upon detection of fault condition; and opening a mechanical switch to interrupt the fault current and isolate the faulty circuit branch within said time window.

### BRIEF DESCRIPTION OF THE DRAWINGS

FIG. 1A illustrates a power circuit using the series-type hybrid circuit breaker (SHCB) with non-resonant current zero-crossing generation disclosed in this invention to provide short circuit fault protection.

FIG. 1B illustrates a series-type hybrid circuit breaker (SHCB) protection scheme for three-phase AC power systems showing the use of three 4-IGBT H-bridge inverters (a total of 12 IGBTs) and 3 single-phase transformers.

FIG. 2 illustrates an embodiment of the invention using a six-IGBT three-leg three-phase inverter, two capacitors, and three single-phase transformers with their primary windings in a star configuration.

FIG. 3 illustrates the transformer primary and secondary current and voltage waveforms of an embodiment according to FIG. 2 during a fault interruption process for Phase A over a time period of 9 to 11 millisecond.

FIG. 4 illustrates the Phase A, B, and C current waveforms, and the capacitor C1 and C2 current and voltage waveforms of an embodiment according to FIG. 2 during a simultaneous fault interruption process for all three phases over a time period of 9 to 11 millisecond.

FIG. 5 illustrates an embodiment of the invention using a six-IGBT three-leg three-phase inverter, two capacitors, and a three-phase transformer.

FIGS. 6A-C illustrate a current waveforms of Phase A, B, and C, respectively, of an embodiment according to FIG. 5 during a simultaneous fault interruption process for all three phases over a time period of 29.2 to 30.8 millisecond.

FIG. 7 illustrates an embodiment of the invention using an eight-IGBT four-leg three-phase inverter, a single capacitor, and three single-phase transformers with their primary windings in a star configuration.

FIG. 8 illustrates waveforms of the transformer primary and secondary current and voltage, and the capacitor current and voltage of an embodiment according to FIG. 7 during a fault interruption process for Phase A over a time period of 2.5 to 3.5 millisecond.

FIG. 9 illustrates current waveforms of Phase A, B, and C of an embodiment according to FIG. 7 during a fault interruption process over a time period of 0.2 to 3 millisecond. Note that the phase currents are sequentially interrupted with a finite delay time required to complete the disruption process of each prior phase (e.g., 0.5 ms in this case study).

FIG. 10 illustrates an embodiment of the invention using an eight-IGBT four-leg three-phase inverter, a single capacitor, and a three-phase transformer.

FIG. 11 illustrates an embodiment of the invention using three existing single-phase transformers with each having a tertiary winding for counter voltage injection.

FIG. 12 illustrates a single-phase transformer with a primary, secondary, and tertiary windings.

FIGS. 13A-C illustrate waveforms of the transformer primary, secondary, and tertiary current and voltage, and the capacitor current and voltage of an embodiment according to FIG. 11 during a fault interruption process for Phase A over a time period of 3 to 5.4 millisecond.

FIG. 14 illustrates a sixth embodiment of the invention using an existing three-phase transformer with three tertiary windings for counter voltage injection.

FIG. 15 illustrates a three-phase transformer with three primary, secondary, and tertiary windings.

### DETAILED DESCRIPTION OF EMBODIMENTS

The invention provides and includes a series-type hybrid circuit breaker with non-resonant current zero-crossing generation method to provide fault interruption in three-phase AC power systems. Embodiments of the invention can be further understood in the following detailed descriptions.

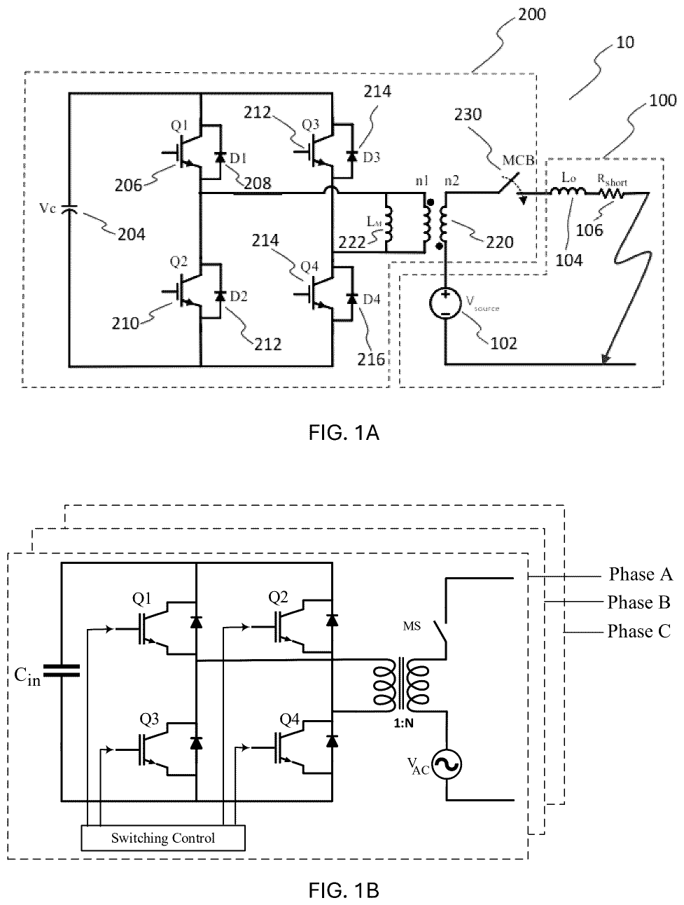

FIG. 1A illustrates a power circuit 100 using the series-type hybrid circuit breaker (SHCB) 200 to provide short circuit fault protection. The SHCB 200 comprises a mechanical circuit breaker (MCB) 230, a pulse transformer 220, and a power electronic circuit connected to the primary side of the transformer 220. The rest of the main power circuit 100 comprises a voltage source 102 (DC or AC type), a loop inductor 104, and a loop resistor 106 to model the short circuit inductance and resistance, respectively. The primary side power electronic circuit comprises a capacitor 204, four transistors Q1 (206), Q2 (210), Q3 (212), and Q4 (214), and four diodes D1 (208), D2 (212), D3 (214), and D4 (216). The main power loop current flows through the secondary winding of the pulse transformer 220. Note that the magnetizing inductance LM 222 is included in the transformer model but the leakage inductances are not for the sake of simplicity. When an overcurrent condition is detected in the main power loop 100, the SHCB 200 is activated by switching the transistors in a controlled manner at a certain switching frequency ranging from 1 to tens of kHz (e.g., between 1 and 90 kHz, preferably between 5 and 20 kHz) to discharge and recharge the pre-charged capacitor 204, as will be described in detail next.

FIG. 1B illustrates a series-type hybrid circuit breaker (SHCB) protection scheme of FIG. 1A extended for three-phase AC applications. It requires the use of three 4-IGBT H-bridge inverters with a total of 12 IGBTs and three single-phase transformers.

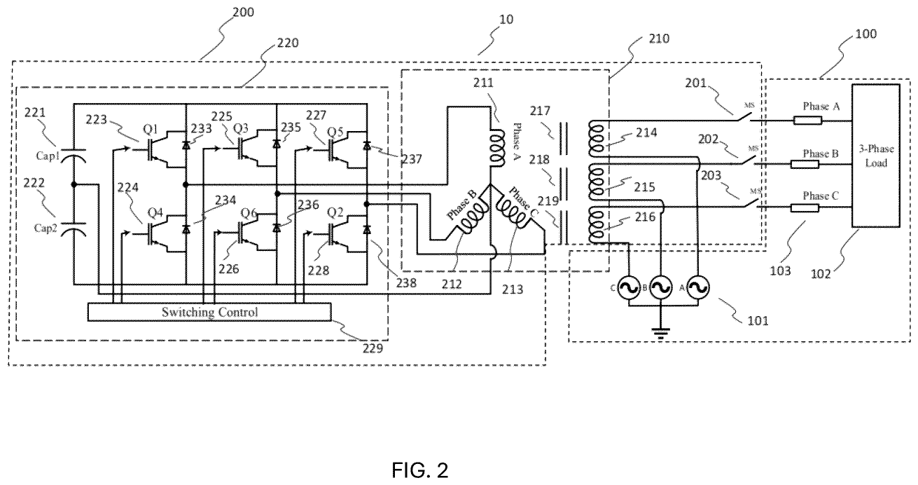

FIG. 2 illustrates an embodiment of the invention using a six-IGBT three-leg three-phase inverter, two capacitors, and three single-phase transformers with their primary windings in a star configuration. A typical three-phase AC power system 10 comprises a main AC circuit 100 and an SHCB fault protection circuit 200. The main AC circuit 100 comprises a three-phase voltage source 101, a loop impedance 103, and a load 102. The three-phase SHCB 200 comprises three fast-disconnection mechanical switches (MS) 201-203, three single-phase pulse transformers 210 with their primary windings in a star configuration, and a power electronic circuit 220 connected to the primary side of the transformer 210. The power electronic circuit 220 comprises two capacitors 221 and 222, six transistors (e.g., IGBTs) Q1 (223), Q2 (228), Q3 (225), Q4 (224), Q5 (227), and Q6 (226), their anti-parallel diodes 233, 238, 235, 234, 237, and 236, and a switching control and gate driver circuit 229. The midpoint of C1 (221) and C2 (222) is connected to the neutral point of the star-connected primary windings of the transformers 210. Each phase current of the main power loop 100 flows from the AC source 101 to the load 102 through the secondary winding of the pulse transformers 210 and the mechanical switches 201-203. When a fault condition is detected in the main power loop 100, the SHCB 200 is activated by switching the transistors in a controlled manner at a certain switching frequency ranging from 1 to tens of kHz (e.g., between 1 and 90 kHz, preferably between 5 and 20 kHz) to discharge and recharge the pre-charged capacitors 221 and 222, as will be described in detail below.

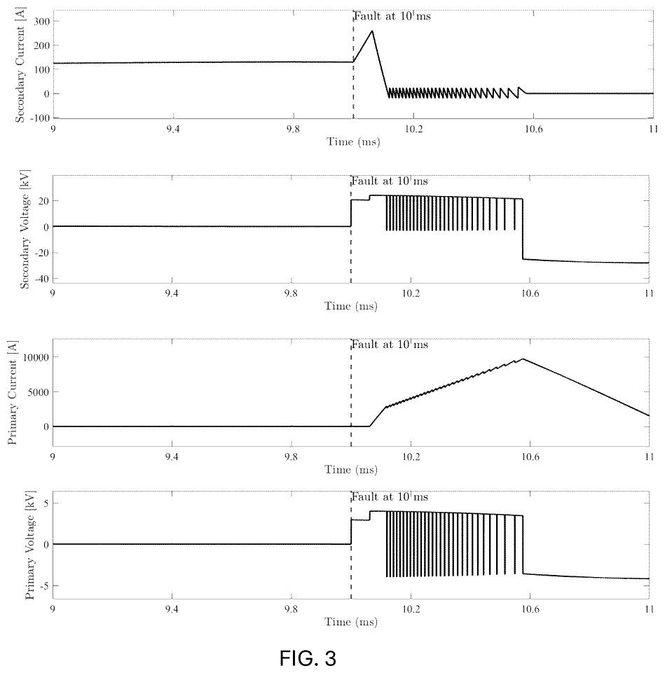

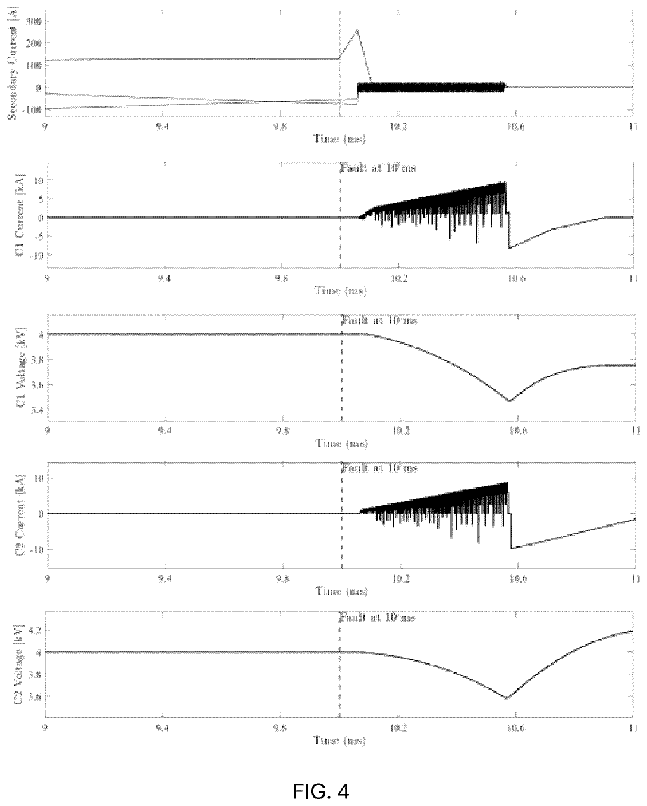

FIG. 3 illustrates the transformer primary and secondary current and voltage waveforms of an embodiment according to FIG. 2 during a fault interruption process for single phase (e.g., Phase A) over a time period of 9 to 11 millisecond. The Phase A load current is at a nominal value of about 120A at 10 ms when a fault occurs in a 15 kV (rms) three-phase case study. The Phase A fault current quickly ramps up to about 260A at 10.05 ms. The SHCB is then activated at this instant and quickly forces the fault current to a high-frequency small-amplitude AC ripple current between 10.1 and 10.6 ms, during which the fast-disconnection mechanical switch 201 can open safely without arcing and isolate the faulty branch at around 10.6 ms. This is achieved by using a hysteresis control method in the switching control and gate driver circuit 229, in which Phase A current is sensed and compared to a preset upper and a lower threshold and a set of gate control pulse width modulation (PWM) signals will be generated. A counter voltage of +21 kV to −3 kV was injected to the main power loop via the pulse transformers 100 during the interruption process. Capacitor 221 and 222 were pre-charged to 4.5 kV in the beginning of the interruption process. The primary current rises to over 10 kA during the interruption process, albeit only for a short period of 0.5 ms. The Phase A fault interruption is used as an example in FIG. 3, but Phase B or C can be independently interrupted in a similar manner. It is worth noting, however, that the disconnection of one or two phases will lead to an undesirable imbalance situation for the three-phase AC system 10 and should be operated with caution. In most fault protection cases, all three phases should be interrupted simultaneously to avoid imbalanced operation. FIG. 4 illustrates the Phase A, B, and C current waveforms, and the capacitor C1 and C2 current and voltage waveforms of an embodiment according to FIG. 2 during a simultaneous fault interruption process for all three phases over a time period of 9 to 11 millisecond. It is observed that individual phase currents, although in opposite directions, can be simultaneously interrupted. Capacitors C1 (221) and C2 (222) take turns to support the “active” and “recharge” operation of the three-phase inverter for each of the three phases. There is a net loss of charge on both C1 and C2 during the fault interruption process, thus sufficiently large C1 and C2 must be selected to maintain enough primary voltage throughout the entire interruption process.

The embodiment of FIG. 2 uses three individual single-phase pulse transformers with their primary windings connected in a star configuration. It can be advantageous to further combine them into a single-core three-phase transformer to reduce size and weight.

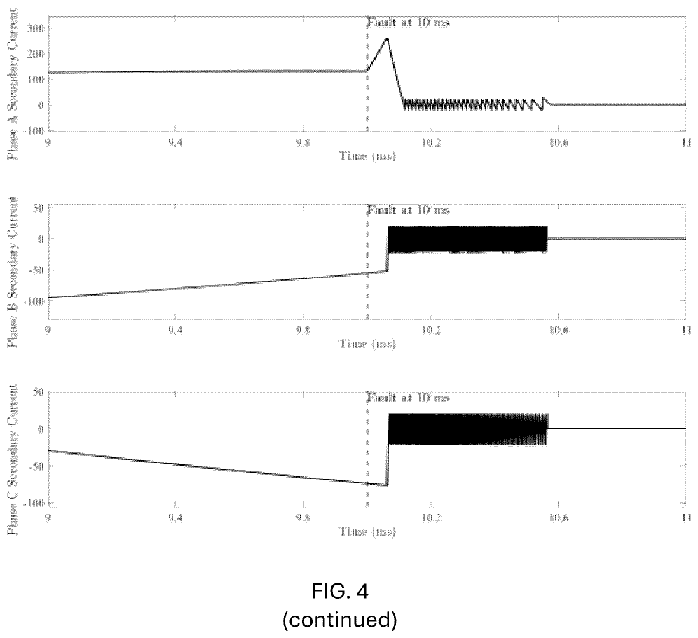

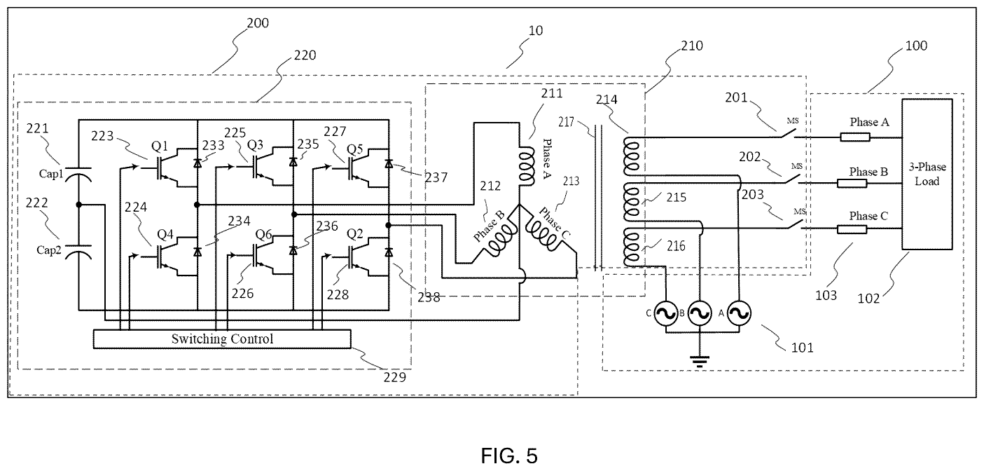

FIG. 5 illustrates an embodiment of the invention using a six-IGBT three-leg three-phase inverter, two capacitors, and a three-phase transformer. This embodiment of the invention operates in a similar manner as FIG. 2. It is worth noting that capacitors C1 (221) and C2 (222) may become imbalanced after each interruption operation and need to be rebalanced through the pre-charging circuit and/or the power electronic circuit 220. FIGS. 6A-C illustrate a current waveforms of Phase A, B, and C, respectively, of an embodiment according to FIG. 5 during a simultaneous fault interruption process for all three phases over a time period of 29.2 to 30.8 millisecond.

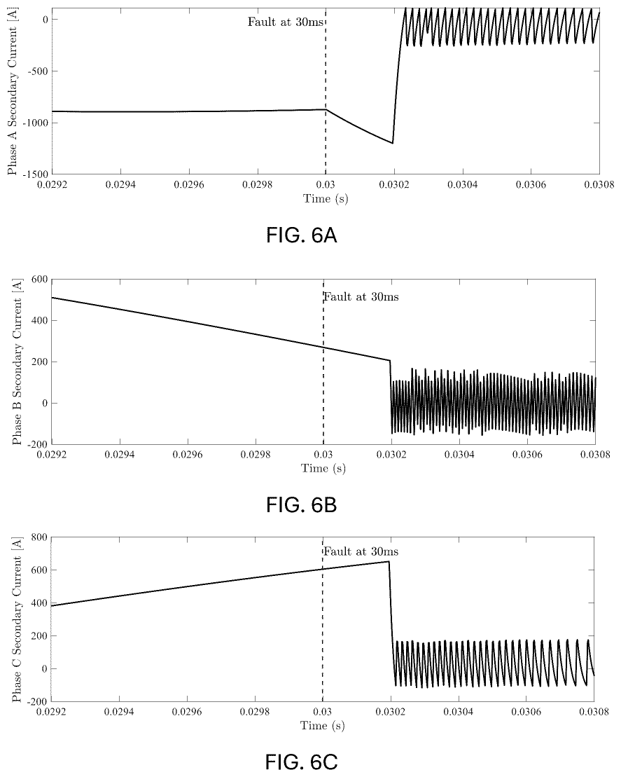

FIG. 7 illustrates an embodiment of the invention using an eight-IGBT four-leg three-phase inverter, a single capacitor, and three single-phase transformers with their primary windings in a star configuration. A main difference between this and FIGS. 1A and 1B is that the SHCB protection circuit 200 of the FIG. 7 uses only one capacitor 221 but an additional phase leg comprising transistors 223 and 224 and anti-parallel diodes 233 and 234. The main advantage of this embodiment is that it offers a higher primary voltage, fewer secondary turns and thus lower secondary resistance and conduction losses.

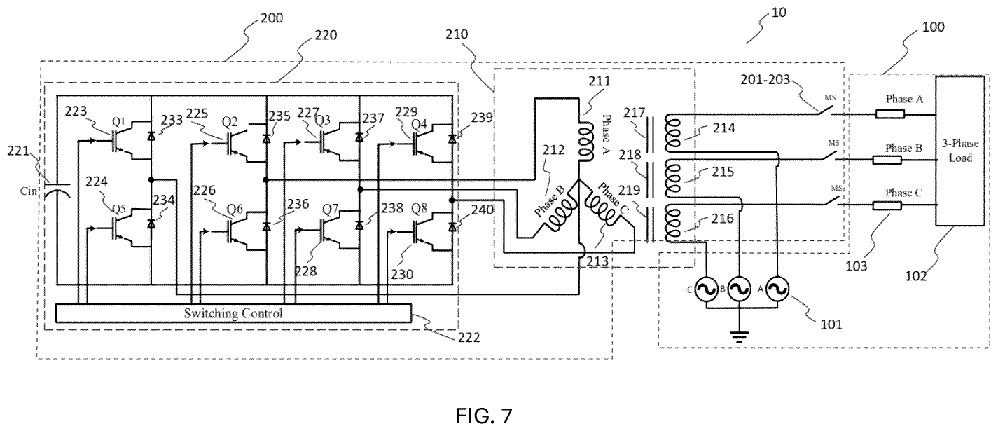

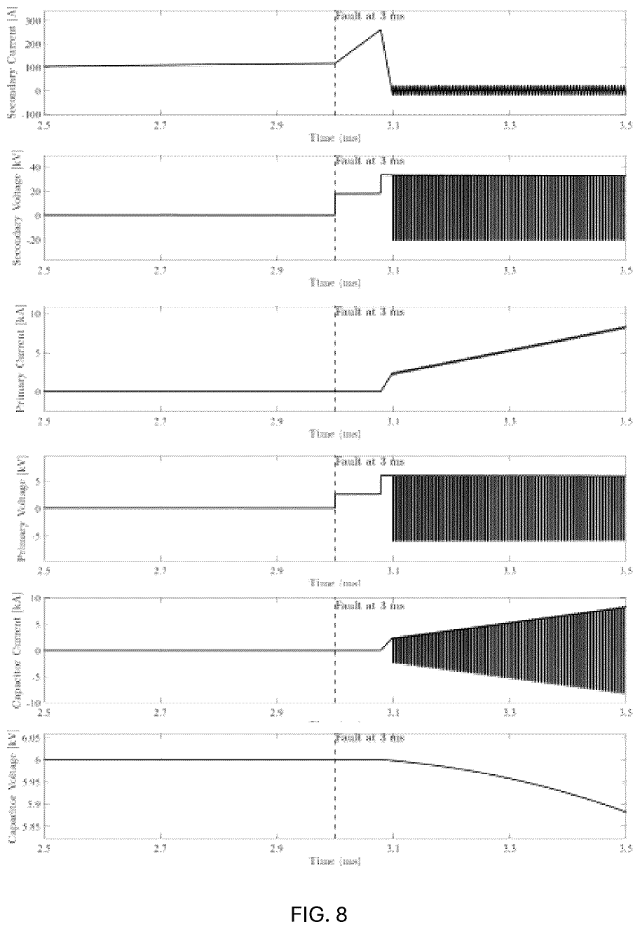

The additional phase leg connects its midpoint to the neutral point of the star-connected primary windings 214-216 of the transformers 210, and sets the neutral point voltage to that of either the positive or negative terminal of the capacitor 221 depending on the state of Q1 (223) and Q2 (224). For example, when Phase A current is in a positive half cycle, Q5 (224) is ON and Q1 (223) is OFF and the neutral point is connected to the negative terminal of the capacitor 221. By turning on Q2 (225), a positive capacitor voltage can be applied to the Phase A primary winding. The SHCB 200 is now in the “active” mode. By turning off Q2 (225), the Phase A primary winding will be connected to the negative capacitor voltage through the freewheeling diodes 236 and 233. The SHCB 200 is thus in the “recharge” mode. By alternately switching Q2 (225) and Q5 (224) in a PWM mode, the Phase A secondary current can be reduced to a high-frequency small-amplitude AC ripple current, allowing the fast-disconnect mechanical switch 201 to open safely. Similarly, Phase B or C fault current can be interrupted by switching Q3 (227) or Q4 (229), respectively, in coordination with the switching of Q1 (223) and Q2 (224) based on the direction of the phase current. FIG. 8 illustrates waveforms of the transformer primary and secondary current and voltage, and capacitor current and voltage of an embodiment according to FIG. 7 during a fault interruption process for Phase A over a time period of 2.5 to 3.5 millisecond. The fault current of each phase can be interrupted independently in the third embodiment of the invention. However, unlike the embodiments of FIGS. 1 and 2, the embodiment of FIG. 7 does not allow simultaneous interruption of all three phases. FIG. 9 illustrates the current waveforms of Phase A, B, and C of an embodiment according to FIG. 7 during a fault interruption process over a time period of 0.2 to 3 millisecond. Note that the phase currents are sequentially interrupted with a finite delay time required to complete the disruption process of each prior phase (e.g., 0.5 ms in this case study).

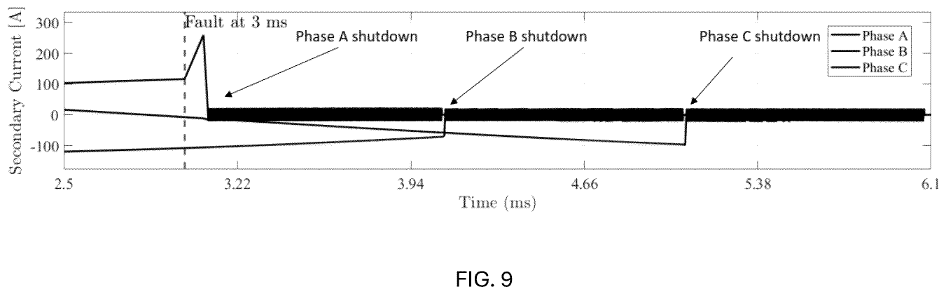

FIG. 10 illustrates an embodiment of the invention using an eight-IGBT four-leg three-phase inverter, a single capacitor, and a three-phase transformer. This embodiment uses a single-core three-phase transformer instead of the three individual single-phase transformers as in FIG. 7, potentially offering size and weight advantages. The embodiment according to FIG. 10 operates similarly to that of FIG. 7, allowing the shutdown of each phase separately but not simultaneously.

Above embodiments of the invention invariably rely on the use of either three single-phase transformers or a single three-phase transformer. The secondary windings of the transformer(s) conduct the load current under normal operation, resulting in additional power losses due to their parasitic resistance. This is one fundamental drawback of the SHCB concept. In most AC distribution systems, conventional power transformers are already widely used to convert between different voltage levels and provide galvanic isolation. It would be advantageous to utilize these existing power transformers without introducing the additional winding losses to serve the purpose of counter voltage injection during a fault interruption process. This can be achieved by adding a tertiary winding to the existing power transformers.

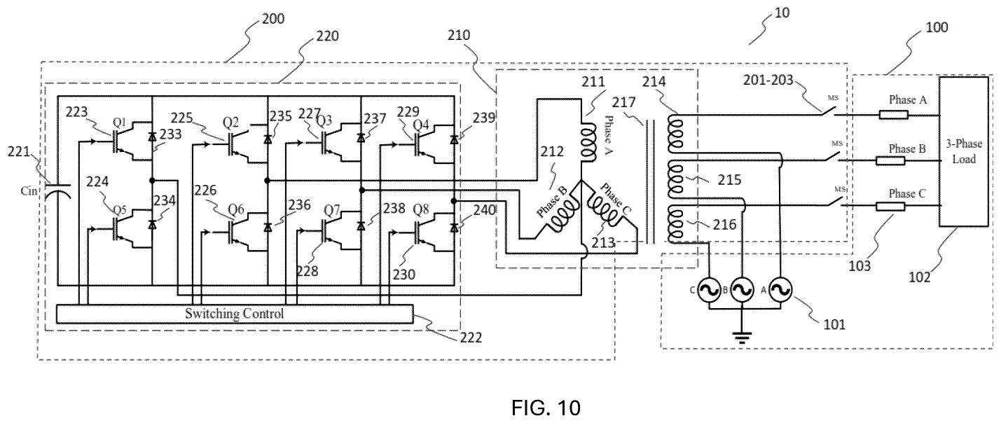

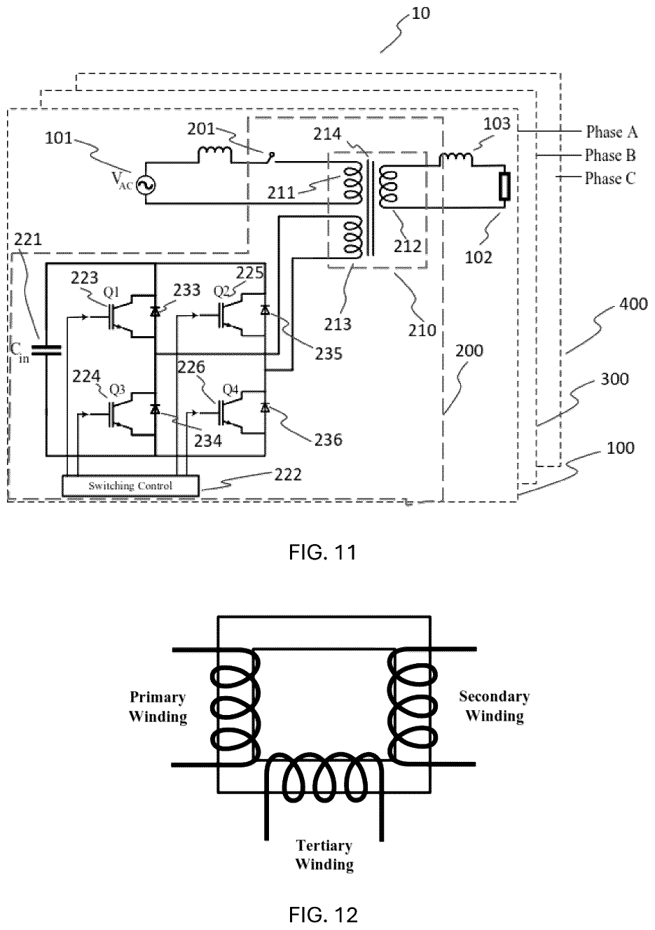

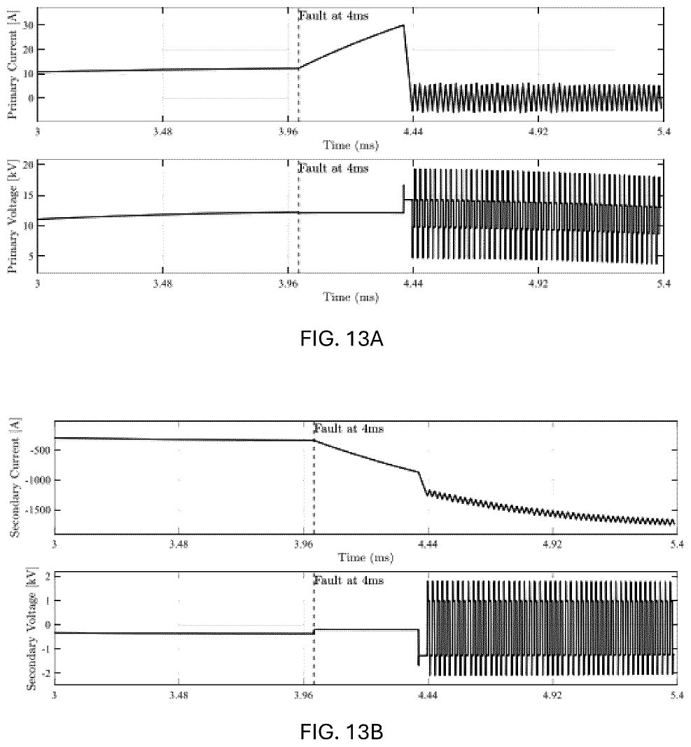

FIG. 11 illustrates an embodiment of the invention using three existing single-phase transformers with each having a tertiary winding for counter voltage injection. FIG. 12 illustrates a single-phase transformer with a primary, secondary, and tertiary winding. A typical three-phase AC power system 10 comprises three phases 100, 300, and 400. Phase A circuit 100 comprises a single-phase voltage source 101, a load 102, some loop impedance, and a single-phase SHCB 200. Circuit 200 comprises a fast-disconnection mechanical switches (MS) 211, a single-phase three-winding pulse transformer 210, and an H-bridge inverter circuit similar to the SHCB. The transformer 210 comprises a common core and a primary winding 211, a secondary winding 212, and a tertiary winding 213. The tertiary winding 213 is connected to the H-bridge inverter which further comprises a capacitor 221, four transistors 223-226, four anti-parallel diodes 233-236, and a control and drive circuit 222. Phase A current flows from the AC source 101 to the load 102 through the coupled primary and secondary windings of the power transformers 210. The H-bridge inverter and the tertiary winding 213 remain inactive under normal operation. When a fault condition is detected in the main power loop, the H-bridge inverter is activated by switching the transistors in a controlled manner at a certain switching frequency to discharge and recharge the pre-charged capacitor 221 and induce a counter voltage across the primary winding 211 through magnetic coupling between primary and tertiary windings. The induced counter voltage will force the primary current to become a high-frequency small-amplitude AC ripple current, allowing the fast-disconnection mechanical switch 211 to open safely, similar to the operation of other embodiments of the invention. FIGS. 13A-C illustrate waveforms of the transformer primary, secondary, and tertiary current and voltage of an embodiment according to FIG. 11 during a fault interruption process for Phase A over a time period of 3 to 5.4 millisecond. In summary, the embodiment of FIG. 11 allows interruption of all three phases simultaneously or selected phase independently.

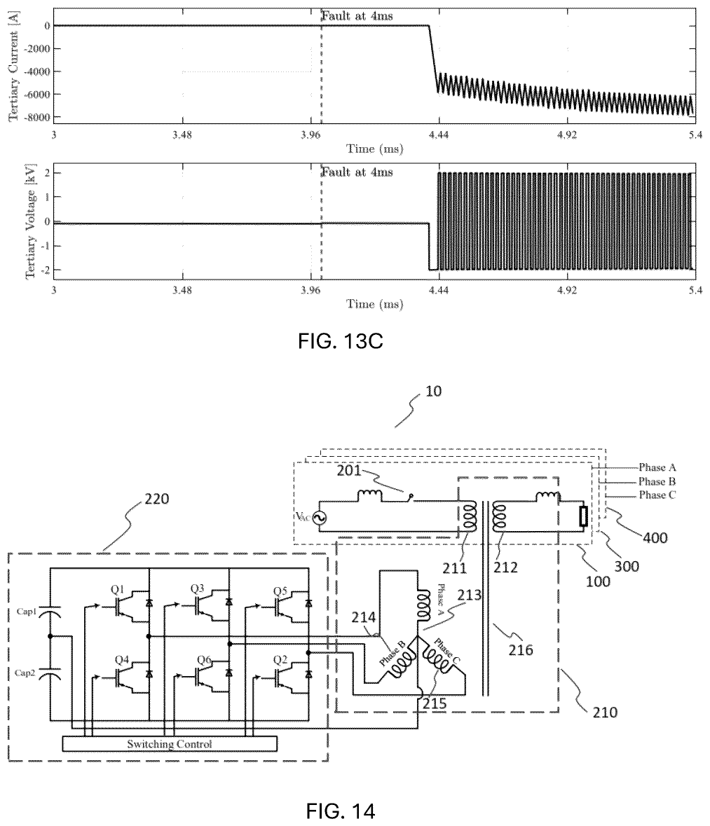

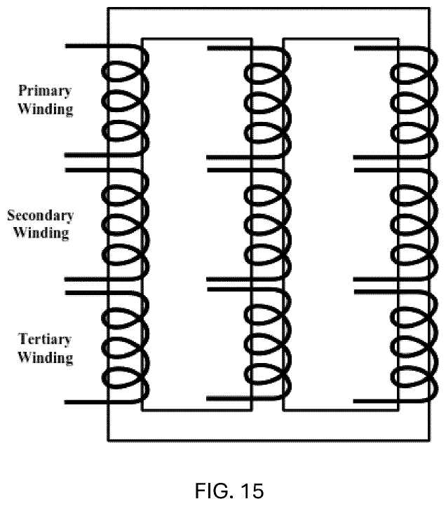

FIG. 14 illustrates an embodiment of the invention using an existing three-phase transformer with three tertiary windings for counter voltage injection. FIG. 15 illustrates a three-phase transformer with three primary, secondary, and tertiary windings. A single three-phase three-winding transformer (instead of three single-phase three-winding transformers), a single six-IGBT three phase inverter (instead of three 4-IGBT inverters; i.e., a total of 12 IGBTs for three phases) are used in this embodiment to further reduce size, weight, and cost.

The following table summarizes the advantages of various embodiments of this invention.

| Three-phase AC | |
|---|---|
| SHCB Embodiment | Advantage(s) |
| FIG. 1B | Interruption of all three phases simultaneously or selected |
| | phase independently |
| FIG. 2 | Lowest component count and cost (6X IGBTs, 2X capacitors), |
| | interruption of all three phases simultaneously or selected |
| | phase independently |
| FIG. 5 | Lowest component count and cost (6X IGBTs, 2X capacitors), |
| | compact single 3-phase transformer, interruption of all three |
| | phases simultaneously or selected phase independently |
| FIG. 7 | Low component count and cost (8X IGBTs, 1X capacitor), |
| | lower secondary winding loss, interruption of selected phase |
| | independently |
| FIG. 10 | Low component count and cost (8X IGBTs, 1X capacitor), |
| | compact single 3-phase transformer, lower secondary winding |
| | loss, interruption of selected phase independently |
| FIG. 11 | No additional transformer winding loss, reuse of three existing |
| | single-phase transformers, interruption of all three phases |
| | simultaneously or selected phase independently |
| FIG. 14 | Lowest component count and cost (6X IGBTs, 2X capacitors), |
| | reuse of existing single 3-phase transformer, no additional |
| | transformer winding loss, interruption of all three phases |
| | simultaneously or selected phase independently |

It will be appreciated that details of the foregoing embodiments, given for purposes of illustration, are not to be construed as limiting the scope of this invention. Although only exemplary embodiments of this invention are described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the future claims. Further, the design parameters, such transformer turn ratio and inductance, capacitor voltage and capacitance, switch frequency and duty cycle can be varied and optimized for better performance and lower cost. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A circuit protection apparatus for interrupting three-phase alternating-current (AC) fault current and isolating the fault from the power system, comprising:
a transformer operable to force a fault current in a main three-phase AC power circuit to cross zero a plurality of times in a form of high-frequency small-amplitude AC current within a specified response time window upon detection of a fault condition;
a power electronic circuit operable to inject a transient voltage to the transformer;
a mechanical circuit breaker in series connection with the transformer, the mechanical circuit breaker operable to interrupt the fault current and isolate the faulty circuit branch within the time window; and
at least one current sensor operable to detect a direction and amplitude of current in each phase of the main power circuit.

2. The apparatus of claim 1, wherein the power electronic circuit comprises:
at least one capacitor operable to discharge and recharge during the fault interruption process;
a plurality of semiconductor switches and/or diodes;
a control circuit to control the switching of the semiconductor switches; and
an isolated power supply to pre-charge the at least one capacitor to certain voltage levels in preparation for generating the transient voltage.

3. The apparatus of claim 1, wherein the transformer comprises a primary winding connected to the power electronic circuit and a secondary winding connected in series with the mechanical circuit breaker in the main power circuit.

4. The apparatus of claim 1, wherein the transformer comprises a primary winding connected to an AC power source through the mechanical circuit breaker, a secondary winding connected to a load, and a tertiary winding connected to the power electronic circuit.

5. The apparatus of claim 1, wherein the specified response time is between about 0.5 and 5 milliseconds.

6. The apparatus of claim 1, wherein an amplitude of the high-frequency AC current is in a range of five to fifty percent of the nominal current of the main power circuit.

7. The apparatus of claim 1, wherein a frequency of the high-frequency AC current is in a range of one to several tens of kilohertz.

8. The apparatus of claim 5, wherein the transformer comprises a primary winding, a secondary winding, and a magnetic core for each of the three phases of the main power circuit.

9. The apparatus of claim 5, wherein the transformer comprises three primary windings, three secondary windings, and a magnetic core for three phases of the main power circuit.

10. The apparatus of claim 6, wherein the transformer comprises a primary winding, a secondary winding, a tertiary winding, and a magnetic core for each of three phases of the main power circuit.

11. The apparatus of claim 6, wherein the transformer comprises three primary windings, three secondary windings, three tertiary windings, and a magnetic core for three phases of the main power circuit.

12. The apparatus of claim 2, wherein the capacitor is discharged to and subsequently recharged by the main power circuit during the fault interruption process.

13. The apparatus of claim 2, wherein the semiconductor switches are operable to control the current going through the pulse transformer and comprise one or more selected from the group consisting of insulated-gate bipolar transistors (IGBTs), thyristors, and power MOSFETs made of silicon or other semiconductors.

14. A method for interrupting three-phase alternating-current (AC) fault current and isolating the fault from the power system, comprising:
detecting a fault condition;
activating a power electronics circuit to force the fault current of all three phases or a selected phase to cross zero a plurality of times in form of high-frequency low-amplitude AC current within a specified response time window upon detection of fault condition; and
opening a mechanical switch to interrupt the fault current and isolate the faulty circuit branch within the time window.

15. The method of claim 14, wherein the power electronic circuit comprises:
at least one capacitor operable to discharge and recharge during the fault interruption process;
a plurality of semiconductor switches and/or diodes;
a control circuit to control the switching of the semiconductor switches;
a pulse transformer operable to inject a transient voltage to the main power circuit to force the fault current to cross zero a plurality of times during the fault interruption process; and
an isolated power supply to pre-charge the at least one capacitor to certain voltage levels in preparation for generating the transient voltage.

16. The method of claim 14, wherein the specified response time is between about 0.5 and 5 milliseconds.

17. The method of claim 14, wherein an amplitude of the high-frequency AC current is in a range of five to fifty percent of the nominal current of the main power circuit.

18. The method of claim 14, wherein a frequency of the high-frequency AC current is in a range of one to several tens of kilohertz.

19. The method of claim 14, further comprising at least one current sensor to detect the amplitude and direction of each phase current.

20. The method of claim 14, further comprising sending a trigger signal to the mechanical switch upon receiving a signal from the power electronic circuit.
